(19) United States
(12) Patent Application Publication
(10) Pub. No.: US 2008/0204323 A1
(43) Pub. Date: Aug. 28, 2008

(54) Antenna Device

(76) Inventors: Akihiko Iguchi, Osaka (JP); Yuki Satoh, Osaka (JP)

Correspondence Address: RATNERPRESTIA, P.O. BOX 980, VALLEY FORGE, PA, 19482, US

(21) Appl. No.: 10/587,599

(22) PCT Filed: Jan. 19, 2006
(86) PCT No.: PCT/JP2006/300691

§ 371 Date: Aug. 2, 2006

(30) Foreign Application Priority Data
Jan. 26, 2005 (JP) 2005-018061

(51) Int. Cl. H01Q 1/38; H01Q 9/04

(52) U.S. Cl. 343/700 MS

(57) ABSTRACT

An antenna device includes a grounding board having an edge, and an antenna provided on the grounding board. The antenna includes a dielectric block having a top surface, a bottom surface, and a side surface, a radiator electrode provided on the top surface, a short-circuit electrode provided on the side surface. The radiator electrode includes a short-circuited end connected to the second end of the short-circuit electrode, and a portion extending from the short-circuited end and along the outer periphery of the top surface of the dielectric block. The portion of the radiator electrode has an open end located at the first side of the dielectric block. The side surface of the dielectric block is substantially flush with the edge of the grounding board. This antenna device improves radiation characteristics of the chip antenna and allowing a communication device to have a small size.

### TECHNICAL FIELD

The present invention relates to an antenna device including a chip antenna.

### BACKGROUND OF THE INVENTION

FIG. 4 is a perspective view of a conventional chip antenna used in an small communication device, such as a mobile phone. The chip antenna includes dielectric block 1, feeding electrode 2 on an outer surface of dielectric block 1, and radiator electrode 3A having a helical shape on the outer surface of dielectric block 1.

In the chip antenna shown in FIG. 4, radiator electrode 3A is formed also on a bottom surface serving as a surface for mounting, thus positioning radiator electrode 3A on a circuit board. This arrangement causes radiation characteristics to deteriorate. Furthermore, a grounding board cannot be formed on a portion of the circuit board on which the chip antenna is mounted, and decreases a space available for mounting other components, accordingly preventing the communications device from having a small size.

### SUMMARY OF THE INVENTION

An antenna device includes a grounding board having an edge, and an antenna provided on the grounding board. The antenna includes a dielectric block having a top surface, a bottom surface, and a side surface, a radiator electrode provided on the top surface, a short-circuit electrode provided on the side surface. The radiator electrode includes a short-circuited end connected to the second end of the short-circuit electrode, and a portion extending from the short-circuited end and along the outer periphery of the top surface of the dielectric block. The portion of the radiator electrode has an open end located at the first side of the dielectric block. The side surface of the dielectric block is substantially flush with the edge of the grounding board.

This antenna device improves radiation characteristics of the chip antenna and allowing a communication device to have a small size.

### BRIEF DESCRIPTION OF DRAWINGS

FIG. 1 is a perspective view of an antenna device in accordance with an exemplary embodiment of the present invention.

FIG. 2 is a perspective view of a chip antenna of the antenna device in accordance with the embodiment.

FIG. 3 is a cross-sectional view of the antenna device at line 3-3 shown in FIG. 1.

FIG. 4 is a perspective view of a conventional chip antenna.

### REFERENCE NUMERALS

5 Bottom Board
5A Edge of Bottom Board
6 Chip Antenna
7 Dielectric Block
7A Top Surface of Dielectric Block
7F Outer Periphery of Dielectric Block
7G Side of Dielectric Block (First Side)
7H Side of Dielectric Block (Third Side)
7J Side of Dielectric Block (Second Side)
7K Side of Dielectric Block (Fourth Side)
8 Feeding Electrode
9 Short-Circuit Electrode
9A End of Short-Circuit Electrode (First End)
9B End of Short-Circuit Electrode (Second End)
10 Radiator Electrode
10A Open End
10B Short-Circuited End
10C Portion of Radiator Electrode (Third Portion)
10D Portion of Radiator Electrode (First Portion)
10E Portion of Radiator Electrode (Fourth Portion)
10F Portion of Radiator Electrode (Second Portion)

### DETAILED DESCRIPTION OF PREFERRED EMBODIMENTS

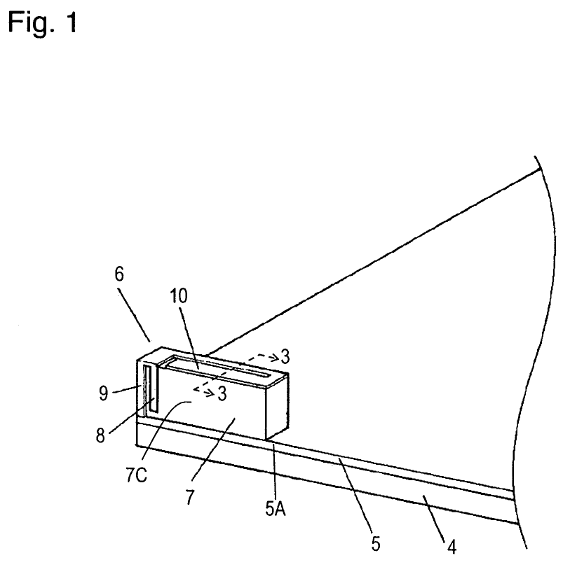

FIG. 1 is a perspective view of an antenna device in accordance with an exemplary embodiment of the present invention. This antenna device includes grounding board 5 for grounding provided on circuit board 4 accommodated in a communication device, such as a mobile phone, and chip antenna 6 mounted on grounding board 5.

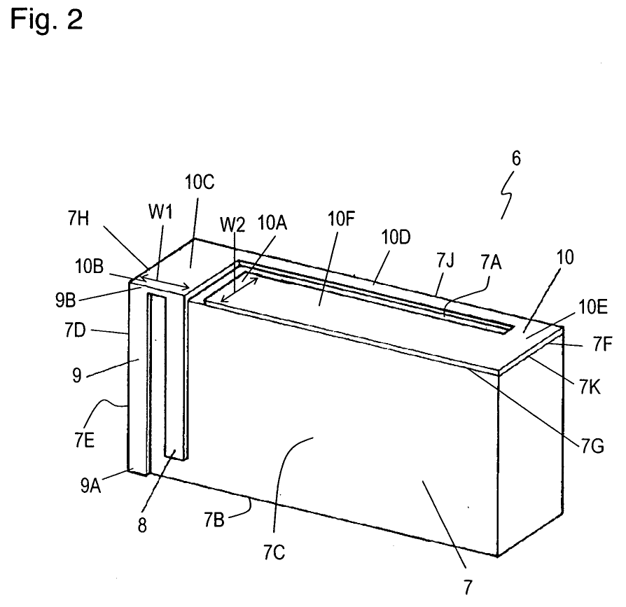

FIG. 2 is a perspective view of chip antenna 6. Chip antenna 6 includes dielectric block 7 made of dielectric material, such as ceramic or resin. Feeding electrode 8, short-circuit electrode 9, and radiator electrode 10 are formed on surfaces of dielectric block 7. Short-circuit electrode 9 has a strip shape having end 9A and end 9B. End 9A is connected to grounding board 5. Radiator electrode 10 has open end 10A and short-circuited end 10B. Short-circuited end 10B is connected with end 9B of short-circuit electrode 9. Thus, chip antenna 6 has a structure of an inverted-F antenna. The sum of the electrical lengths of radiator electrode 10 and short-circuit electrode 9 is determined to be λ/4 (λ being the wavelength of a frequency used). Feeding electrode 8 is electrically connected with short-circuited end 10B of radiator electrode 10, and supplies, to radiator electrode 10, a high-frequency signal of the above frequency. The high-frequency signal of the frequency is taken out from radiator electrode 10.

Dielectric block 7 has a rectangular shape and has top surface 7A, bottom surface 7B opposite to top surface 7A, side surface 7C, and side surface 7E connected with side surface 7C at side 7D. Top surface 7A has outer periphery 7F. Outer periphery 7F has side 7G, side 7H, side 7J opposite to side 7G, and side 7K opposite to side 7H. Both of side 7H and side 7K are connected with side 7G and side 7J. Side 7G connects top surface 7A with side surface 7C. Side 7H connects top surface 7A with side surface 7E. Short-circuit electrode 9 has a strip shape provided on side surface 7C along side 7D. Feeding electrode 8 has a strip shape provided on side surface 7C and in parallel to short-circuit electrode 9. Short-circuited end 10B of radiator electrode 10 is connected with end 9B of short-circuit electrode 9 at side 7G. Radiator electrode 10 has four portions 10C to 10F. Portion 10C extends from short-circuited end 10B along side 7H. Portion 10D extends from portion 7C along side 7J. Portion 10E extends from portion 10D along side 7K. Portion 10F extends from portion 10E along side 7G. That is, radiator electrode 10 almost surrounds outer periphery 7F of top surface 7A from short-circuited end 10B. An end of portion 10F is positioned on side 7G and serves as open end 10A.

As shown in FIG. 1, antenna chip 6 is mounted on grounding board 5 so that bottom surface 7B of dielectric block 7 contacts grounding board 5. Side surface 7C of dielectric block 7 is substantially flush with edge 5A of grounding board 5. This arrangement increases radiation characteristics of the antenna device and provides the antenna device with a small size.

The communication device including this antenna device includes a cabinet. Circuit board 4 is places in a predetermined area in the cabinet, hence limiting the position of grounding board 5. This antenna device allows grounding board 5 to be located underneath dielectric block 7, hence allowing other components to be mounted on a portion of grounding board 5 where chip antenna 6 is not mounted. That is, this antenna device secures a large area in a limited region in which grounding board 5 can be placed, accordingly providing the communication device with a small size.

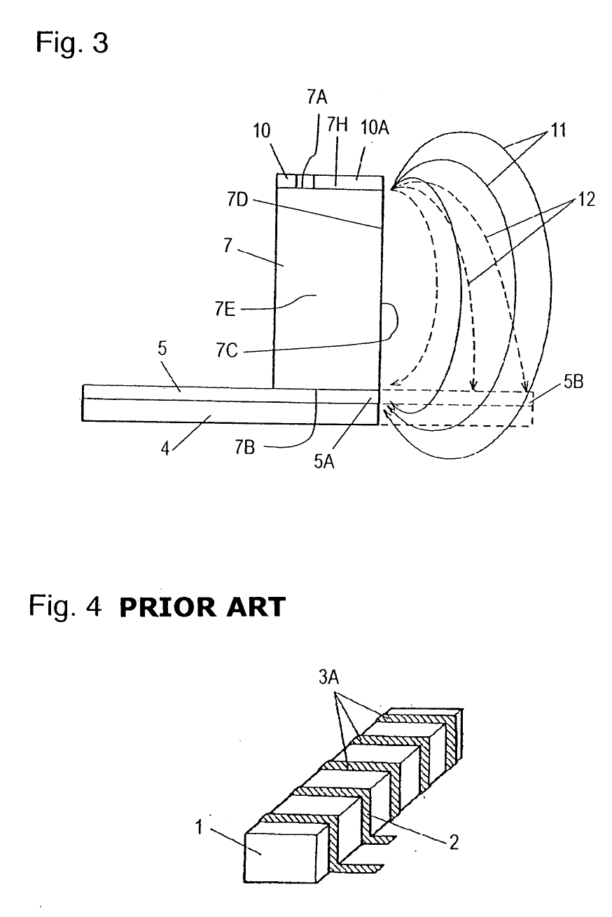

FIG. 3 is a cross-sectional view of the antenna device at line 3-3 shown in FIG. 1 and shows radiation characteristics of the antenna device. Side surface 7C of dielectric block 7 is provided between open end 10A that has a high potential within radiator electrode 10 and grounding board 5 that provides a ground potential. Side surface 7C is a essential portion for generating an electric field that determines radiation characteristics of chip antenna 6. Side surface 7C is substantially flush with and close to open end 10A of radiator electrode 10. Since edge 5A of grounding board 5 is close to side surface 7C of dielectric block 7, electric field 11 emitted from chip antenna 6 tends to be influenced by grounding board 5. If grounding board 5 has edge 5B that projects from side surface 7C of dielectric block 7, electric field 12 emitted from chip antenna 6 is attracted to projecting grounding board 5, accordingly causing radiation efficiency of the antenna device to deteriorate. Edge 5A of grounding board 5 is positioned close to side surface 7C of dielectric block 7. In FIG. 3, edge 5A does not project from side surface 7C, and side surface 7C is substantially flush with edge 5A of grounding board 5. This structure increases the radiation efficiency of chip antenna 6.

Radiator electrode 10 having portions 10C to 10F is positioned round top surface 7A along outer periphery 7F of top surface 7A of dielectric block 7 starting from short-circuited end 10B. This structure allows radiator electrode 10 to have a physical length efficiently within such predetermined area. The potential of open end 10A is higher than potentials of other positions within radiator electrode 10. Open end 10A is positioned close to short-circuited end 10B which has a grounding potential, accordingly being coupled with short-circuited end 10B with a capacitance. This capacitance functions as a loading capacitance that has an effect substantially shortening the wavelength of the high frequency signal in radiator electrode 10, and accordingly, allows radiator electrode 10 to have a small physical length, thus allowing chip antenna 6 and the antenna device to have small sizes.

As shown in FIG. 2, width W2 of open end 10A of radiator electrode 10 is determined to be greater than width W1 of short-circuited end 10B. This structure allows open end 10A having high radiation efficiency to have a large area, accordingly allowing chip antenna 6 to be used over a wide range. Impedance of the path from short-circuited end 10B of radiator electrode 10 21 through portions 10C to 10F to open end 10A changes depending on the difference between widths Wi and W2. This change in impedance produces an effect of shortening the wavelength of the high frequency signal, thus allowing chip antenna 6 to have a small size.

### INDUSTRIAL APPLICABILITY

A antenna device in accordance with the present invention has improved radiation characteristics and has a small size, thus being useful especially in a mobile communication device, such as a mobile telephone.

1. An antenna device comprising:
a grounding board having an edge;
an antenna provided on the grounding board, the antenna including
a dielectric block having a top surface, a bottom surface opposite to the top surface, and a side surface connected to the top surface and the bottom surface, the top surface having an outer periphery,
a radiator electrode provided on the top surface,
a short-circuit electrode provided on the side surface, the short-circuit electrode having a first end and a second end, the first end of the short-circuit electrode being connected to the grounding board, the second end of the short-circuit electrode being connected to the radiator electrode, and
a feeding electrode provided on the side surface and connected to the radiator electrode, wherein the bottom surface of the dielectric block contacts the grounding board,
wherein the outer periphery of the top surface of the dielectric block has a first side at which the top surface is connected with the side surface,
wherein the radiator electrode includes
a short-circuited end connected to the second end of the short-circuit electrode, and
a portion extending from the short-circuited end along the outer periphery of the top surface of the dielectric block, the portion of the radiator electrode having an open end located at the first side of the dielectric block, and
wherein the side surface of the dielectric block is substantially flush with the edge of the grounding board.

2. The antenna device of claim 1, wherein a width of the open end of the radiator electrode is greater than a width of the short-circuited end of the radiator electrode.

3. The antenna device of claim 1,
wherein the outer periphery of the top surface of the dielectric block further has a second side opposite to the first side; and
wherein the radiator electrode further includes
a first portion extending along the second side, and
a second portion extending along the first side.

4. The antenna device of claim 3,
wherein the outer periphery of the top surface of the dielectric block further has
a third side connected to the first side and the second side of the outer periphery, and
a fourth side connected to the first side and the second side, the fourth side of the outer periphery being opposite to the third side of the outer periphery,
wherein the radiator electrode further includes
a third portion extending from the short-circuited end along the third side, and
a fourth portion extending along the fourth side,
wherein the first portion extends from the third portion to the fourth portion; and
wherein the second portion extends from the fourth portion.
